(19) United States
(12) Patent Application Publication
(10) Pub. No.: US 2008/0078631 A1
(43) Pub. Date: Apr. 3, 2008

(54) DISC BRAKE IN COMBINATION WITH BRUSHLESS ELECTRIC MOTOR-GENERATOR

(76) Inventors: Lester J. Erlston, Beaverton, OR (US); Michael D. Miles, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 11/937,432

(22) Filed: Nov. 8, 2007

Related U.S. Application Data
(63) Continuation-in-part of application No. 11/461,912, filed on Aug. 2, 2006.
Application No. 11/461,912 is a continuation-in-part of application No. PCT/US2005/003781, filed on Feb. 3, 2005.
(60) Provisional application No. 60/882,450, filed on Dec. 28, 2006.
(60) Provisional application No. 60/542,523, filed on Feb. 5, 2004.

(51) Int. Cl. B60L 7/10; H02K 7/102

(52) U.S. Cl. 188/159; 310/77

(57) ABSTRACT

A combination brake and motor-generator comprises a disc brake including a brake caliper and one or more rotors; a brushless pancake electric motor-generator including a stator of one or more electromagnets and a rotor having a plurality of radially arrayed, angularly-spaced permanent magnets of alternating polarity. The rotor of the disc brake and the rotor of the motor-generator can be coupled to rotate together or the disc brake and motor-generator can share a common rotor.

### RELATED APPLICATION DATA

This application claims of the benefit of U.S. provisional patent application Ser. No. 60/882,450, filed Dec. 28, 2006, and is a continuation-in-part of U.S. patent application Ser. No. 11/461,912, filed Aug. 2, 2006, which is a continuation-in-part of PCT/US2005/003781, filed Feb. 3, 2005, which claims benefit of U.S. provisional patent application Ser. No. 60/542,523, filed Feb. 5, 2004, all of which are incorporated herein by reference.

### FIELD OF THE INVENTION

This invention relates to disc brakes in combination with brushless electric motor-generators.

### BACKGROUND OF THE INVENTION

Pancake electric motors typically permit axial compactness while enabling large motor rotor diameters for higher power and torque generation. The pancake electric motor may be operated as a generator using the motor rotor as a mechanical input device. In this mode, current induced in the electromagnets' coils by the rotation of the rotor charges an electricity storage device such as a battery or supercapacitor.

Disc brakes, in typical automotive, rail vehicle, light aircraft and similar applications employ a rotor located on the axle or wheel hub and a caliper mechanism that clamps brake pads against both sides of the rotor, creating friction and generating braking force. Disc brakes may employ annular calipers that clamp annular brake pads, in effect stator discs, into contact with the rotor surfaces to create friction. In most commercial and military aircraft, multiple rotors are splined to the inside of the wheel rim and multiple stators are splined to a torque tube affixed to the undercarriage; a pressure plate compresses the stack of rotor and stator discs against a back plate fitted to the torque tube.

In conventional disc brake usage a vehicle's kinetic energy is dissipated as heat when the brakes are applied. An improvement for vehicles using electricity for motive power, such as electric and hybrid vehicles, is the combination of a disc brake with an electric generator whereby a proportion of the kinetic energy is regenerated as electricity during braking and transferred to a storage device, such as a battery or supercapacitor, for future use. It is advantageous for the generator also to function as an electric motor to provide additional motive power to propel the vehicle via the brake rotor, axle, drive shaft or hub to which it is mounted.

### SUMMARY OF THE INVENTION

The invention relates to a combination friction brake and kinetic energy regeneration and electric drive mechanism that combines a disc brake and a brushless pancake electric motor-generator in an integrated mechanism for optimum space, weight and component utilization by coupling, combining or integrating the brake rotor and the rotor of the motor, by coupling, combining or integrating the brake caliper with the motor stator, and by coupling, combining or integrating the motor stator with the vehicle hub carrier or suspension upright (sometimes called, when located at steerable wheels, a steering knuckle). Preferred pancake electric motor-generators include, but are not limited to, those disclosed in U.S. Pat. Nos. 6,552,460 and 6,930,433 and US Pat. Application Publication No. US 2006/0119215, a continuation-in-part application to the '460 and '433 patents, which are hereby incorporated by reference in their entirety. The brushless DC electric motor-generators as disclosed in the abovementioned patents and application comprise a disc or ring-like rotor having a plurality of equally spaced permanent magnets of alternating polarity arrayed radially about the rotor periphery that electromagnetically engages with a plurality of electromagnets that form the stator. When energized, the stator electromagnets are triggered to switch polarity in a sequence that attracts and repels the pen anent magnets, causing the rotor to rotate.

The disc brake of the invention comprises at least one rotor and may be actuated by electric, hydraulic, mechanical or pneumatic means. The disc brake may be of the fixed or floating caliper type and may employ fixed or floating rotors. The combination disc brake-motor-generator mechanism may have a) a common rotor, b) the brake rotor and the motor-generator rotor coupled to rotate together, or c) the brake rotor provided with features that enable it to function as an pancake electric motor-generator rotor. Such features may include, but are not limited to, perpendicular, angled, parallel or concentric coaxial annular flanges or projecting elements located on the periphery and/or one or both sides of the rotor, on which is mounted a plurality of equally spaced permanent magnets or magnetic domains mounted in alternating polarity that magnetically engage with the electromagnetic stator elements of the motor-generator. The annular flanges or projecting elements may be affixed to or integral with the rotor. The annular flanges or projecting elements may use different materials and manufacturing processes to that of the rotor, such as, but not limited to, cast, stamped or forged aluminum, steel and titanium, and carbon fiber. The rotor and annular flanges or projecting elements may be vented, vaned, ribbed, drilled and otherwise shaped, formed or featured to dissipate heat and/or cause or assist cooling of the rotor and other brake-motor-generator components, and may incorporate insulation materials to minimize heat transfer from the braking surfaces to the magnets, sensors and other brake and motor-generator components.

In order to transmit motor and brake torque reaction, the combined disc brake-motor-generator mechanism must be rigidly and robustly affixed to a non-rotatable member of the vehicle, either at the wheel, outboard of the suspension, or on the vehicle inboard of the suspension. In the majority of automotive applications, disc brake calipers are located at the wheel, typically mounted and affixed to a non-rotatable suspension upright, hub carrier or steering knuckle, while the brake rotor is affixed to the wheel hub so as to rotate with the wheel. In a weight, cost and component saving embodiment of the invention, the motor-generator stator housing may be affixed to or combined or integrated with the vehicle suspension upright or hub carrier either inboard or outboard of the upright. The vehicle axle or spindle is rotatably located in the suspension upright. The motor-generator rotor and the brake rotor are coupled or combined coaxially to a common shaft such as an axle, drive-shaft, half-shaft or spindle.

The combined disc brake-motor-generator system may be compatible with various electronic vehicle control and management systems including skid, stability, and traction control systems. The kinetic energy regeneration and reuse brake device is suitably wired to operate during braking, coasting on a trailing throttle and acceleration. The generator function is activated, by appropriate switch devices, when the accelerator is released or the brakes are applied. Applying the accelerator or releasing the brakes disengages the generator function. While the generator function is engaged, the rotation of the vehicle's wheels causes current to be induced in the electromagnets' coils and stored in an electric power storage device such as a battery or supercapacitor. The electric motor function may be engaged, either automatically when the accelerator is applied, or at the driver's discretion by means of a switch device or other engagement mechanism.

The brushless pancake electric motor-generators of the types disclosed in, but not exclusive to the '460 and '433 patents and the '215 application offer advantages of high torque, low weight and axial compactness. The motor-generator rotor's disc-like architecture makes it suitable for combining or coupling with, or forming an integral part of, a disc brake rotor. Similarly, the motor-generator's stator architecture makes it suitable for combining or coupling with, or forming an integral part of, a disc brake caliper and a suspension upright. In addition to savings in reduced complexity, weight and component cost, this combination provides the opportunity for locating the brake-motor-generator mechanism within a conventional vehicle wheel without creating excessive unsprung weight.

The invention may be used to enable full-time or as-needed all-wheel-drive functionality and capability in a two-wheel-drive vehicle by fitting the invention to the front wheels of a rear-wheel-drive vehicle or by fitting the invention to the rear wheels of a front-wheel-drive vehicle.

The foregoing and other objects, features and advantages of the invention will become more readily apparent from the following detailed description of preferred embodiments of the invention which proceed with reference to the accompanying drawings. The same or similar parts are indicated by the same reference numerals.

### BRIEF DESCRIPTION OF THE DRAWINGS

FIGS. 1A-1D illustrate the rotor, permanent magnet and electromagnet configurations according to the '460 and '433 patents and the '215 application.

FIG. 2 is a cross-sectional partial view of a disc brake in combination with an pancake electric motor-generator with the motor-generator stator combined or integral with a suspension upright or hub carrier.

FIG. 3 is a partial plan view of a disc brake in combination with an pancake electric motor-generator.

FIGS. 4A and 4B are cross-sectional partial views of a disc brake in combination with an pancake electric motor-generator, the motor-generator stator housing affixed to or integral with a suspension upright or hub-carrier, and illustrate alternative methods of coupling or combining the brake rotor with the electric motor-generator rotor.

FIG. 5 is a cross-sectional view of an pancake electric motor-generator rotor fitted with a perpendicular flange on which are mounted two rows of equally spaced permanent magnets of alternating polarity that electromagnetically engage with a plurality of pairs of “u”-shaped electromagnets.

FIG. 6 is a cross-sectional view of a coaxial helically actuated multiple rotor disc brake sharing a common rotor with a brushless pancake electric motor-generator.

FIGS. 7A and 7B are cross-sectional partial views of a coaxial helically actuated multiple rotor disc brake actuated by a brushless pancake electric motor, showing the brake in released and applied states respectively.

FIG. 8 is a schematic cutaway plan view of a front-wheel-drive vehicle fitted with combination friction brake and kinetic energy regeneration and electric drive mechanisms mounted at the rear wheels to provide all-wheel-drive functionality.

### DETAILED DESCRIPTION

The '460 and '433 patents disclose a plurality of single-gapped toroidal or “c”-shaped electromagnets that electromagnetically engage with a single ring of equally spaced permanent magnets of alternating polarity radially arrayed about the periphery of the rotor that passes between the single gap formed by the space between the two arms of the “c”. The '215 application discloses a double-gapped version of the pancake motor-generator that employs pairs of half-toroidal or “u”-shaped electromagnets, the pairs of “u”-shaped electromagnets having their arms facing each other and spaced apart to form two gaps through which two rings or rows of equally spaced permanent magnets of alternating polarity radially arrayed about the periphery of the rotor may pass. It is believed that the double-gapped version may offer power and torque advantages over the single-gapped version. Both the single-gapped and double-gapped versions of the pancake motor-generator are compatible with the current invention.

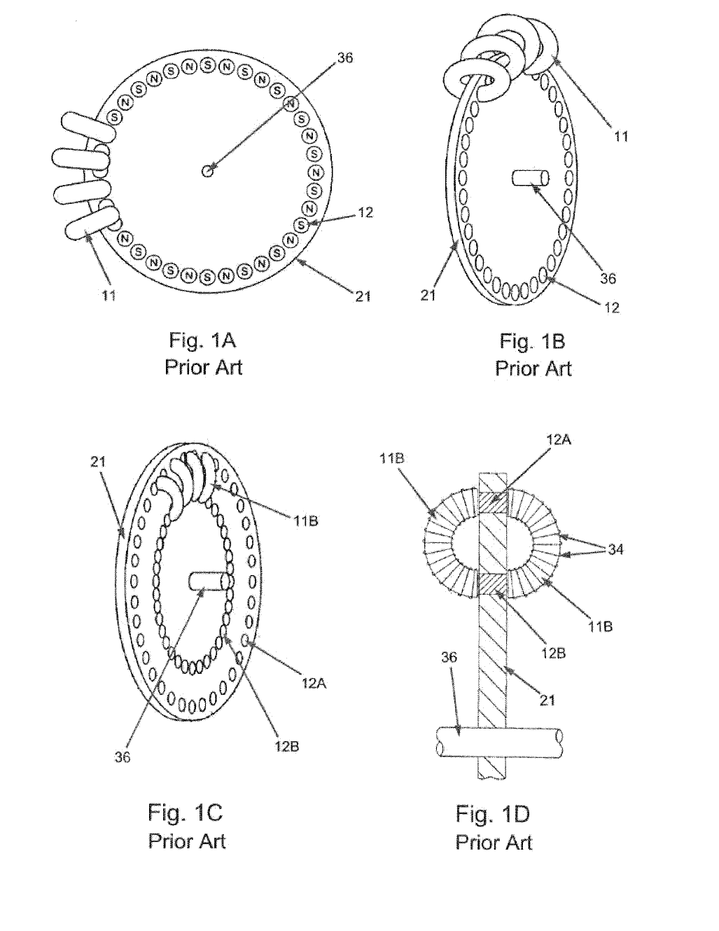

FIGS. 1A and 1B depict a brushless DC electric motor-generator with a rotor, permanent magnet and electromagnet configuration according to the '460 and '433 patents. FIGS. 1C and 1D depict the rotor, permanent magnet and electromagnet configuration according to the '215 application. FIG. 1A is a plan view and FIG. 1B a perspective view of such a brushless DC electric motor-generator comprising a stator having a series of electromagnets 11 and a plurality of equally spaced permanent magnets 12 of alternating polarity mounted on rotor 21 so as to electromagnetically engage with the slotted electromagnets 11 of the stator in the manner described in the '460 and '433 patents. Electromagnets 11 may be of toroidal, “c” shaped or other suitable shape, and are slotted or gapped to enable the plurality of permanent magnets 12 of alternating polarity on rotor 21 to pass through. Rotor shaft 36 is affixed at the center of rotor 21. FIG. 1C is a perspective view and FIG. 1D a cross-sectional view of a brushless DC electric motor-generator comprising a stator having a series of electromagnets 11B and an outer ring 12A of equally spaced permanent magnets of alternating polarity and an inner ring 12B of equally spaced permanent magnets of alternating polarity mounted on rotor 21 so as to engage electromagnetically with electromagnets 11B of the stator in the manner described in the '215 application. Electromagnets 11B may be half-toroidal, “u-shaped” or other suitable shape. A pair of such half-toroidal or “u-shaped” electromagnets 11B are spaced apart with their arm ends facing each other to enable the plurality of equally spaced permanent magnets 12A and 12B on rotor 21 to pass through. Windings 34 are shown around electromagnets 11B.

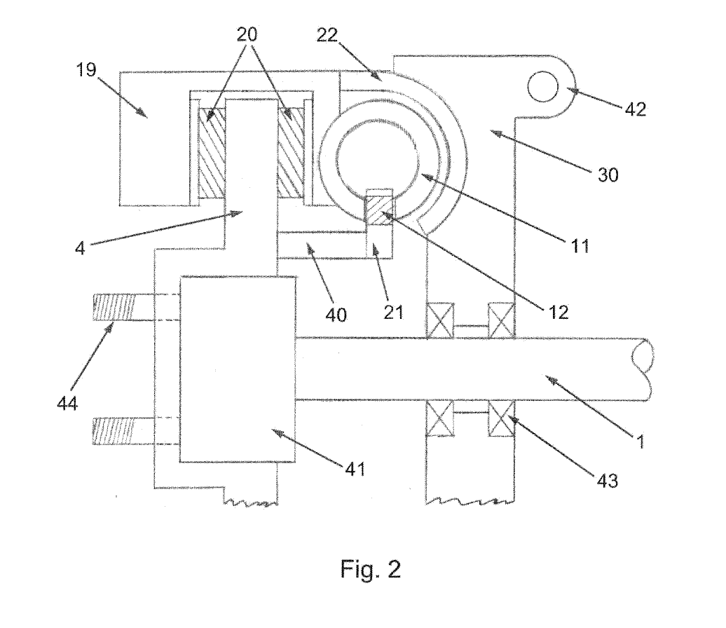

An embodiment of the current invention comprises a disc brake having a conventional hydraulic brake caliper in combination with a brushless pancake electric motor-generator of the type disclosed in the '460 and '433 patents and the '215 application, the rotors of the disc brake and the electric motor-generator coupled to rotate together. FIG. 2 illustrates a conventional hydraulic caliper disc brake of the type produced by a number of brake manufacturers including Akebono, Brembo and Continental Teves, and comprises a brake caliper 19 with brake pads 20 located either side of brake rotor 4 mounted on axle 1. In this embodiment, brake rotor 4 is parallel to and coupled to pancake electric motor-generator rotor 21 by means of coaxial annular coupling flange 40 which is perpendicular to and affixed to or integral with brake rotor 4 and/or motor-generator rotor 21. The coupling flange 40 is cylindrical and, besides supporting rotor 21 spaced axially from brake rotor 4, serves to reinforce or stiffen both rotors. A plurality of equally spaced permanent magnets 12 of alternating polarity are mounted to motor-generator rotor 21 so as to engage a gap in the “c”-shaped electromagnets 11 of the motor-generator stator in the manner described in the '460 and '433 patents. Electromagnets 11 are mounted in stator housing 22 which is affixed to or integral with brake caliper 19. Stator housing 22 is affixed to or integral with vehicle suspension upright or hub carrier 30, which is fitted with suspension arm brackets 42 and axle bearings 43. Axle 1 is rotatably supported in axle bearings 43. Wheel hub 41 is fitted with wheel mounting bolts 44. Brake rotor 4 is mounted on wheel hub 41 and located by wheel mounting bolts 44.

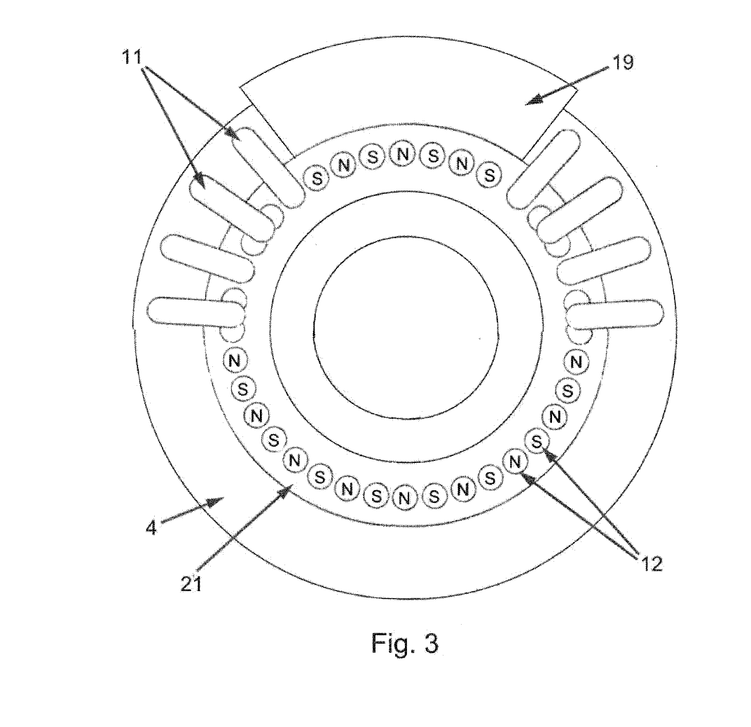

FIG. 3 shows a side view of an pancake electric motor-generator stator, comprising two sets of electromagnets 11 located radially on either side of brake caliper 19, that engage with a plurality of equally spaced permanent magnets 12 of alternating polarity mounted on motor-generator rotor 21. Motor-generator rotor 21 is coupled to brake rotor 4 by means of perpendicular coaxial annular flange 40 as shown in FIG. 2. Stator housing 22 and upright 30 shown in FIG. 2 are not shown in FIG. 3 so that the sets of electromagnets 11 are visible.

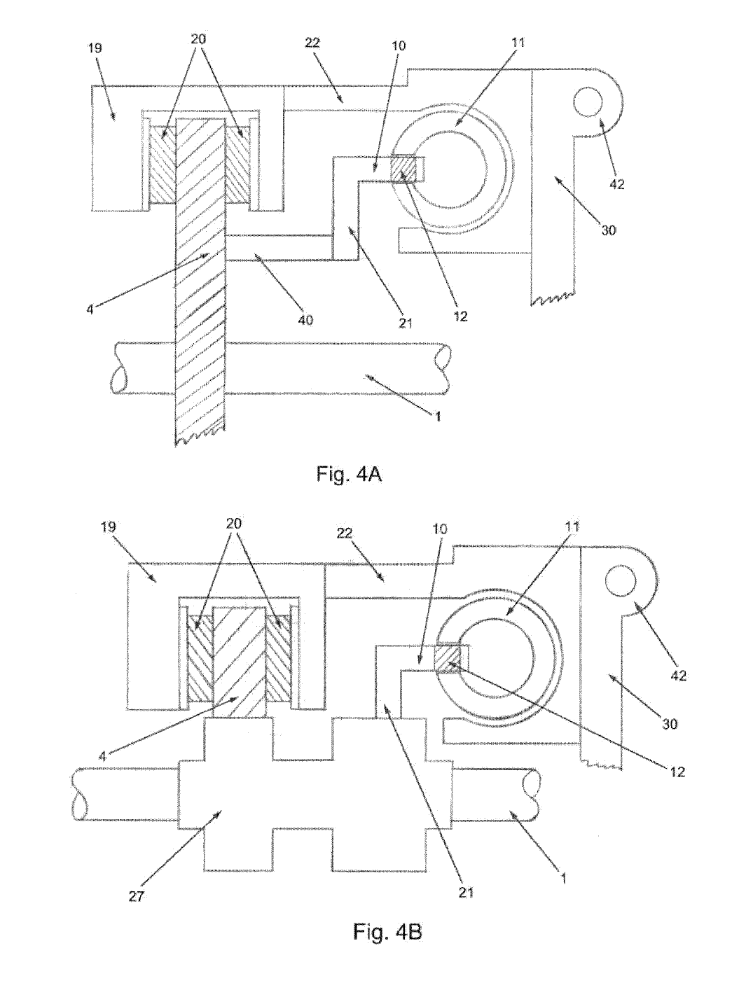

FIGS. 4A and 4B depict two further embodiments of a caliper disc brake in combination with a pancake electric motor-generator. Both embodiments have a plurality of equally spaced permanent magnets 12 of alternating polarity mounted on a perpendicular coaxial annular flange 10 that is affixed to or integral with motor-generator rotor 21. The plurality of equally spaced permanent magnets 12 of alternating polarity mounted on perpendicular coaxial annular flange 10 electromagnetically engages with slotted “c”-shaped electromagnets 11 located within stator housing 22. Thus, the flange 10 carrying magnets 12 forms a cylinder which is perpendicular to brake rotor 4 and rotor 21. Stator housing 22 is affixed to or integral with brake caliper 19, and the stator housing/brake caliper unit is fixedly mounted to or integral with vehicle suspension upright or hub carrier 30 which includes suspension arm mounting bracket 42. In FIG. 4A motor-generator rotor 21 is coupled to brake rotor 4 by means of coaxial annular coupling flange 40 which is perpendicular to and affixed to or integral with brake rotor 4 and motor-generator rotor 21. FIG. 4B shows motor-generator rotor 21 coupled to brake rotor 4 by means of common mounting hub 27.

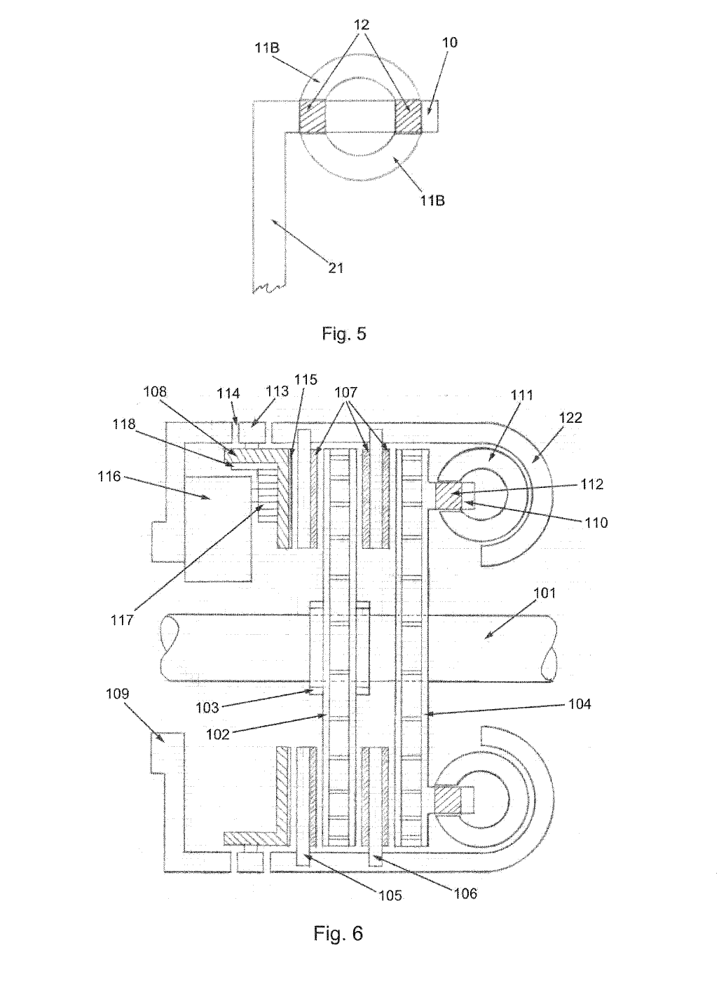

FIG. 5 is a cross-sectional view of a periphery of a pancake electric motor-generator rotor 21 fitted with perpendicular coaxial annular flange 0 on which are mounted two rows of equally spaced permanent magnets 12 of alternating polarity that electromagnetically engage with a plurality of pairs of “u”-shaped electromagnets 11B. This arrangement may be used in any of the embodiments described herein.

Another embodiment of the invention comprises a combination of a coaxial helically actuated disc brake as disclosed in Applicant's US Patent Application Publication No. US 2006/0260886, incorporated by reference, which employs an annular caliper mechanism and annular brake pads, and a brushless electric generator-motor of the type disclosed in '460 and '433 patents and the '215 application. FIG. 6 illustrates a coaxial helically actuated disc brake mechanism that includes an axially slidable floating rotor 102 located on the vehicle drive shaft or axle 101 by means of splines 103, and an axially fixed rotor 104 fixedly mounted on the vehicle drive shaft or axle 101. Floating rotor 102 is positioned nearer to an annular pressure plate 108. Fixed rotor 104 is positioned nearer electromagnets 111 of the motor-generator stator and has on its surface adjacent to electromagnets 111 a perpendicular coaxial annular or cylindrical flange 110. A plurality of equally spaced permanent magnets 112 of alternating polarity of said brushless electric motor-generator are located on annular flange 110. Annular flange 110 may be affixed to or integral with the rotor surface and is shaped and arranged in such a fashion that a plurality of permanent magnets 112 of alternating polarity electromagnetically engage with a plurality of electromagnets 111 that comprise the motor-generator stator. Alternatively, a double row of magnets and “u”-shaped electromagnets, as shown in FIG. 5, can be used. Another embodiment may use an annular cylindrical flange to connect a motor rotor parallel to fixed brake rotor 104, as shown in FIG. 2, with perpendicular annular flange 40 connecting brake rotor 4 with parallel motor rotor 21 on which is mounted a single row of equally spaced permanent magnets 12 of alternating polarity. Alternatively, two concentric rows of equally spaced permanent magnets 12A and 12B of alternating polarity, as shown in FIGS. 1C and 1D, may be employed in conjunction with a stator comprising a plurality of “u”-shaped electromagnets 11B.

The motor-generator stator is affixed to brake support element 109 in a stator housing 122 affixed to or integral with brake support element 109. Annular brake pad carriers 105 and 106 are axially slidably mounted on support element 109 which is affixed to the vehicle to transmit the braking torque. Pad carrier 105 is located between pressure plate 108 and floating rotor 102 and pad carrier 106 between floating rotor 102 and fixed rotor 104. Pad carriers 105 and 106 have friction material or suitable friction facings 107 affixed to or integral with their surfaces adjacent to the rotor braking surfaces.

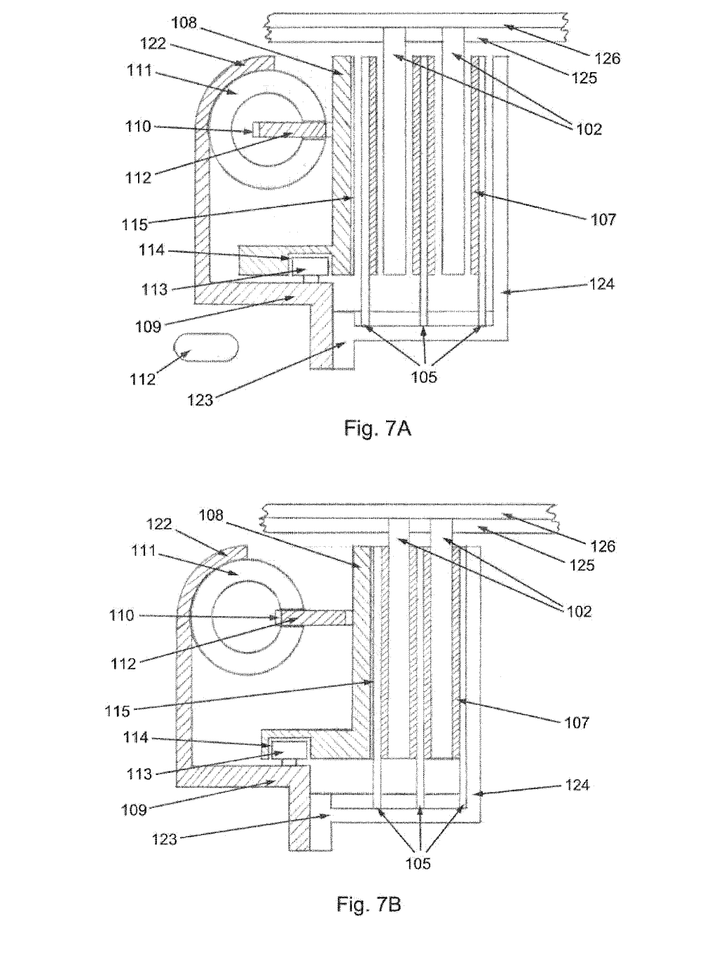

The coaxial helically actuated brake's helical mechanism comprises a series of track rollers 113 running in helical tracks 114 formed in support element 109. Pressure plate 108 is driven by an actuator 116, for example in this embodiment an electric gear motor, by means of pinion 117 meshing with gear rack 118 affixed to pressure plate 108. Alternative actuation means include pneumatic and hydraulic cylinders oriented tangentially to pressure plate 108, and brushless electric motors as disclosed in, but not exclusive to, the '460 and '433 patents and the '215 application and described hereunder with reference to FIGS. 7A and 7B.

When the brake is actuated, because pressure plate 108 is rotatably mounted on support element 109 by means of the helical mechanism comprising track rollers 113 running in helically shaped tracks 114, pressure plate 108 moves axially in a helical motion away from stator electromagnets 111 towards pad carrier 105. Pressure plate 108 has a low friction element 115, such as the Diamond-Like Carbon (DLC) coating manufactured by Bekaert Advanced Coating Technologies, on its surface facing adjacent pad carrier 105. Low friction element 115 enables smooth disengagement or decoupling of pressure plate 108 from pad carrier 105 by preventing helically rotating pressure plate 108 from tightening and seizing against adjacent pad carrier 105.

The electric motor-generator may be operated as a motor or as a generator depending on the arrangement of the electronic switching controls employed. When the brake is actuated pressure plate 108 axially pushes pad carrier 105, floating rotor 102 and pad carrier 106 against fixed rotor 104, creating braking friction. Since this embodiment employs both sides of floating rotor 102 and one side of fixed rotor 104 as friction surfaces, one more friction surface than that of a single rotor disc brake, it is able to generate about 50% greater brake torque than a disc brake of equal rotor diameter, or equivalent brake torque with smaller diameter rotors, so permitting reduced overall brake size and weight. The larger friction surface area also provides enhanced heat distribution and dissipation enabling lower friction material and rotor temperatures. To prevent friction generated heat from damaging permanent magnets 112 located on flange 110 of fixed rotor 104, insulating material, vents and other cooling features may be incorporated into flange 110 and rotor 104.

Electronic control devices are arranged to control the operation of the brushless electric motor-generator. In the aforementioned embodiments, when the vehicle is in motion, pushing the brake pedal actuates the brake and simultaneously causes the electric motor-generator to convert a portion of the brake torque to electricity which is transferred to an electricity storage device. The stored electric power may automatically or at the driver's discretion be used to power the electric motor-generator, acting as a motor, to augment the vehicle's main power source. The generator function may be wired to generate electric power while the vehicle is coasting. Releasing the accelerator switches the generator function on, and using the accelerator switches the generator function off. The brushless electric motor-generator of the '460 and '433 patents may be modified to energize the electromagnets in a sequence that is opposite to the direction of rotor rotation so as to retard the rotational speed of the rotor.

In a further embodiment of the invention, brushless electric motors of the type disclosed in, but not exclusive to, the '460 and '433 patents and the '215 application are employed to actuate the pressure plate of a coaxial helical disc brake mechanism such as disclosed in US Patent Application Publication No. US 2006/0260886. The coaxial helical mechanism imparts a helical advance motion (which couples rotational motion to axial motion) to the pressure plate to achieve uniform force across the pressure plate. FIGS. 7A and 7B are cross-sectional views of such a coaxial helical disc brake in released and applied states respectively. Pressure plate 108 is rotatably mounted on support element 109 by means of a series of radially spaced track rollers 113 affixed to support element 109 which run in a circumferentially distributed series of helically shaped tracks 114 located in pressure plate 108.

The brushless electric motor stator, comprising one or more slotted electromagnets 111 in stator housing 122, is fixedly mounted to brake support element 109 or other non-rotatable member and electromagnetically engages a plurality of permanent magnets 112 equally spaced and mounted in alternating polarity in coaxial annular or cylindrical flange 110 affixed to or integral with pressure plate 108. Flange 110 is mounted perpendicular to the rear surface of pressure plate 108 to enable pressure plate 108 to move axially away from electromagnets 111 comprising the motor stator toward brake stator pad carriers 105 and rotors 102 when pressure plate 108 is helically rotated during actuation. Permanent magnets 112 are of sufficient axial length and may be helically oriented so as to maintain electromagnetic engagement with stator electromagnets 111 over the helical axial travel of pressure plate 108. Permanent magnets 112 may be of rectangular, oblong or obround shape in plan view with the longer side corresponding to the helical axial travel of pressure plate 108. Torque tube 123 is mounted on support element 109 and is fitted with a back plate 124. Stator pad carriers 105 are mounted in a splined fashion on torque tube 123 so as to allow them to move axially on torque tube 123. Friction material 107 is affixed to the surfaces of stator pad carriers 105 that are adjacent to the surfaces of rotors 102. Rotors 102 are located in a splined fashion on splines 125 inside wheel rim 126. Pressure plate 108 has a low friction element 115, such as the Diamond-Like Carbon (DLC) coating manufactured by Bekaert Advanced Coating Technologies, on its surface facing adjacent stator pad carrier 105.

When the brake is applied, stator electromagnets 111 rotate pressure plate 108 by means of a triggered sequential electromagnetic engagement with permanent magnets 112 mounted on flange 110 affixed or integral with pressure plate 108. Since pressure plate 108 is rotatably mounted on support element 109 by means of a helical device comprising track rollers 113 running in helically shaped tracks 114, pressure plate 108 moves axially away from stator electromagnets 111 during actuation. A plurality of rectangular or obround permanent magnets 112 of alternating polarity are located length-wise axially on the coaxial annular flange 110 and permit constant electromagnetic engagement between permanent magnets 112 and stator electromagnets 111 as pressure plate 108 moves axially away from stator electromagnets 111 towards the stack of brake stators 105 and rotors 102. Pressure plate 108 axially forces brake stators 105 and rotors 102 against back plate 124 to create braking friction. Low friction element 115 enables smooth disengagement or decoupling of pressure plate 108 from innermost stator pad carrier 105 by preventing helically rotating pressure plate 108 from tightening and seizing against adjacent stator pad carrier 105.

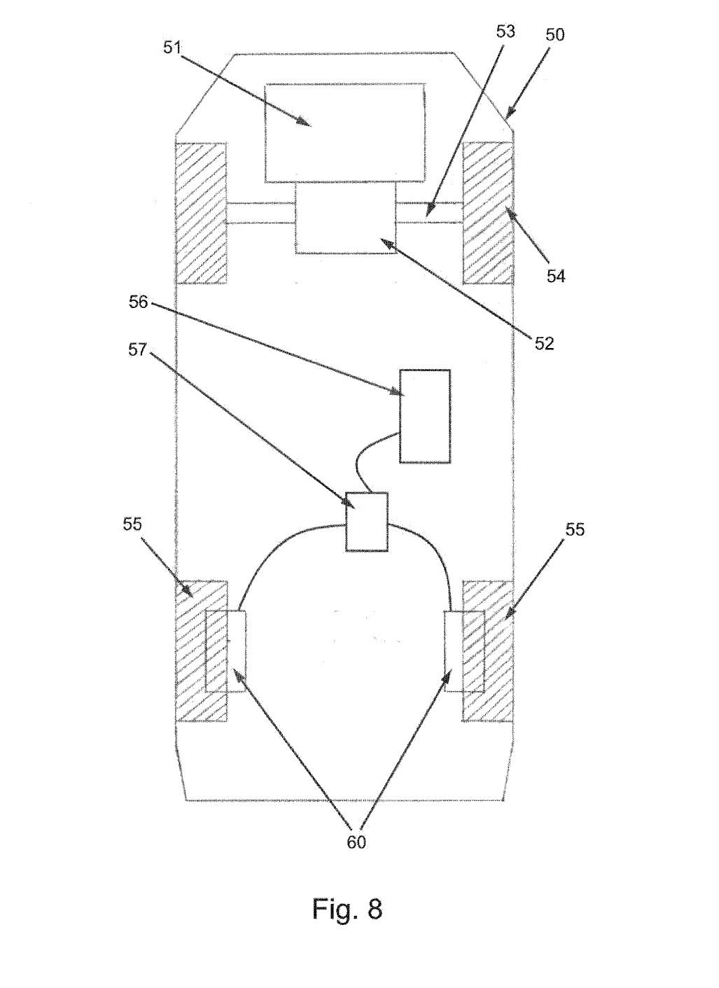

FIG. 8 is a schematic cutaway plan view of a front-engined front-wheel-drive vehicle 50 showing engine 51 mounted to transmission 52, with front axles 53 taking the drive from transmission 52 to front wheels 54. Combination friction brake and kinetic energy regeneration and electric drive mechanisms 60 as described above are mounted at the vehicle's rear wheels 55. This embodiment of the invention enables a front-wheel-drive vehicle to be provided with all-wheel-drive functionality and capability, either full time or as needed, independent of the vehicle's primary motor. Specifically, during times when only front-wheel drive is employed, combination friction brake and kinetic energy regeneration and electric drive mechanisms 60 are operated in generator mode and thereby generate electric current during braking and coasting operations. The electric charge may be stored in a storage device 56, such as a battery or supercapacitor. During times when four-wheel-drive is employed, the combination friction brake and kinetic energy regeneration and electric drive mechanisms 60 operate in motor mode and receive electric current from the storage device 56 to thereby drive the rear wheels 55. In this way, this embodiment may provide kinetic energy recovery during braking or coasting when the vehicle is operating only in front-wheel-drive mode and also provide all-wheel-drive capability, as desired. A controller 57 may be used to switch the combination friction brake and kinetic energy regeneration and electric drive mechanisms 60 between motor and generator modes. The controller 57 may change the mode of the combination friction brake and kinetic energy regeneration and electric drive mechanisms 60 based on an input from an operator of the vehicle, or in response to the operating condition of the vehicle.

A rear-wheel drive vehicle can similarly be provided with all-wheel drive functionality as well as regenerative braking at the front wheels.

Having described and illustrated the principles of the invention in the preferred embodiments thereof it should be apparent that the invention can be modified in arrangement and detail without departing from such principles. We claim all modifications and variations coming within the spirit and scope of the invention. The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications and variations would come within the scope of this invention.

1. A combination brake and motor-generator, comprising:
a disc brake including a brake caliper and one or more rotors;
a brushless pancake electric motor-generator including a stator of one or more electromagnets and a rotor having a plurality of radially arrayed, angularly-spaced permanent magnets of alternating polarity.

2. The combination of claim 1 in which the rotor of the disc brake and the rotor of the motor-generator are coupled to rotate together.

3. The combination of claim 1 in which the disc brake and motor-generator share a common rotor having a plurality of radially arrayed, equally spaced permanent magnets located in substantially the same plane as the rotor friction surfaces.

4. The combination of claim 1 including a coaxial flange projecting axially from the rotor of the disc brake on which is located the plurality of equally spaced permanent magnets of alternating polarity arranged to electromagnetically engage with the electromagnets of the motor-generator stator.

5. The combination of claim 1 in which the brake caliper and a stator housing for the electromagnets are affixed or integrated together.

6. The combination of claim 1 in which a stator housing for the electromagnets is affixed to or integrated together with a vehicle suspension upright, hub carrier or steering knuckle.

7. The brushless electric motor-generator of claim 1 including controls operable to energize the electromagnets in a sequence that is opposite to the direction of rotor rotation so as to retard the rotational speed of the rotor.

8. The combination according to claim 1 in which the motor rotor and the brake rotor are coupled coaxially to a common shaft.

9. A coaxial helically actuated disc brake comprising:
at least one brake stator;
at least one brake rotor;
a pressure plate;
rotatable helical actuation means for moving the pressure plate axially to compress the brake stator and brake rotor together; and
a plurality of equally spaced permanent magnets of alternating polarity mounted on a coaxial flange element affixed to or integral with the periphery or rear surface of the pressure plate of a coaxial helically actuated disc brake, the flange oriented perpendicularly to the pressure plate to permit electromagnetic engagement with a plurality of electromagnets of an electric motor-generator stator and to permit the pressure plate to move axially away from the stator.

10. A disk brake according to claim 9 in which the permanent magnets are of rectangular, oblong or obround shape in plan view and are oriented length-wise axially on the coaxial flange to maintain constant electromagnetic engagement with the electromagnets of the stator as the pressure plate moves axially relative to the stator.

11. A brushless electric motor-generator comprising:
a stator of one or more electromagnets and a rotor having a plurality of radially arrayed, equally spaced permanent magnets of alternating polarity;
the rotor including a disc rotatable about an axis coaxial with the stator and having at least one coaxial flange or projecting element affixed to or integral with a side of the disc;
the radially arrayed, equally spaced permanent magnets of alternating polarity distributed radially around the coaxial flange or projecting element and the electromagnets of the stator positioned adjacent the side of the disc in position to engage electromagnetically the plurality of permanent magnets of alternating polarity.

12. A disk brake according to claim 11 in which the coaxial flange or projecting element is arranged perpendicular to the rotor and the permanent magnets are of rectangular, oblong or obround shape in plan view and oriented axially length-wise on the coaxial flange or projecting element to maintain constant engagement with the electromagnets of the stator as the rotor moves axially towards or away from the stator.

13. A disk brake according to claim 11 in which the coaxial flange or projecting element of claim 10 configured to maximize torque of the motor-generator by maximizing the radial distance between the axis of the motor-generator rotor and the electromagnetic engagement point of the radially arrayed plurality of permanent magnets or magnetic domains with the electromagnets.

14. A coaxial helically actuated disc brake comprising:
at least one brake stator;
at least one brake rotor;
a pressure plate;
rotatable helical actuation means for moving the pressure plate axially to compress the brake stator and brake rotor together; and
a plurality of equally spaced permanent magnets of alternating polarity mounted on a coaxial flange element affixed to or integral with the periphery or surface of a brake rotor of a coaxial helically actuated disc brake, the flange oriented perpendicularly to the brake rotor to permit electromagnetic engagement with a plurality of electromagnets of an electric motor-generator stator.

15. A brushless electric motor-generator comprising:
a stator of one or more electromagnets and
a rotor having a plurality of radially arrayed, equally spaced permanent magnets of alternating polarity;
the rotor including a disc rotatable about an axis coaxial with the stator and having at least one coaxial flange element affixed to or integral with a side of the disc;
the plurality of equally spaced permanent magnets of alternating polarity distributed radially around the coaxial flange element and the electromagnets of the stator positioned adjacent the side of the disc in position to engage electromagnetically the plurality of permanent magnets of alternating polarity.

16. A brushless electric motor-generator according to claim 15 in which the coaxial flange element is oriented perpendicularly to a plane of rotation of the rotor.
